(19) United States
(12) Patent Application Publication
(10) Pub. No.: US 2016/0150516 A1
(43) Pub. Date: May 26, 2016

(54) WIRELESS COMMUNICATION SYSTEM, BASE STATION, AND CONTROL METHOD

(71) Applicant: NEC CORPORATION, Tokyo (JP)

(72) Inventor: Takeshi ANDO, Tokyo (JP)

(21) Appl. No.: 14/903,437

(22) PCT Filed: Jul. 7, 2014
(86) PCT No.: PCT/JP2014/003587

§ 371 Date: Jan. 7, 2016

(30) Foreign Application Priority Data
Jul. 10, 2013 (JP) 2013-144536

(51) Int. Cl. H04W 72/04; H04L 5/00

(52) U.S. Cl. CPC H04W 72/046; H04W 72/048; H04L 5/0032; H04L 5/0048; H04W 88/08

(57) ABSTRACT

[Problem] To provide a wireless communication system, a base station, and a control method, whereby it is possible for the base station to control an active antenna transmission beam wherein an upstream reference signal is used. [Solution] A wireless communication system comprises a first base station further comprising an active antenna, and a second base station which is adjacent to the first base station. Using an upstream reference signal from a wireless terminal, the second base station estimates a direction of the wireless terminal with respect to the second base station, and transmits direction information which is the estimated result and location information of the second base station to the first base station. The first base station receives the direction information and the location information of the second base station, and, on the basis of the direction information, the location information of the second base station, and location information of the first base station, controls a transmission beam of the active antenna of the first base station.

### TECHNICAL FIELD

The disclosure of the present description relates to a wireless communication system, a base station, and a control method, and relates particularly to control of a transmission beam of an active antenna.

### BACKGROUND ART

To increase wireless capacity and to improve throughput, the parallel use of multiple base stations, for example, a system combining transmission base stations, has been proposed (e.g., NPL 1).

PTLs 1 and 2 each disclose a control method in which a base station including an active antenna system estimates the location of a terminal and controls an antenna beam so that the antenna beam is to be directed to the terminal, thereby reducing inter-beam interference in the downlink and consequently increasing the efficiency in communication with the terminal.

### CITATION LIST

### Patent Literature

[PTL 1] Japanese Unexamined Patent Application Publication No. 2001-127699

[PTL 2] Japanese Unexamined Patent Application Publication No.

2008-294728

### Non Patent Literature

[NPL 1] Proposal for concept of “Small Cell Enhancements” for Release 12 put forward in 3GPP Workshop (3GPP Workshop on Release 12 and onwards Ljubljana, Slovenia, Jun. 11 to 12, 2012 “Requirements, Candidate Solutions & Technology Roadmap for LTE Rel-12 Onward) URL: “http://www.3gpp.org/Future-Radio-in-3GPP-300-attend”

### SUMMARY OF INVENTION

### Technical Problem

However, transmission base stations each including an active antenna normally do not have the function of carrying out transmission path estimation by receiving a reference signal of an uplink control channel. For this reason, it is difficult for such a transmission base station to control a transmission beam of the active antenna by way of transmission path measurement using an uplink reference signal.

In view of the above problem, an aim of exemplary embodiments of the present invention is to provide a wireless communication system, a base station, and a control method that enable the base station including an active antenna to control a transmission beam of the active antenna by use of an uplink reference signal. Note that, however, the above-described aim is merely one of multiple aims that the exemplary embodiments disclosed in the present description attempt to achieve. The other aims, or other problems and new aspects, are made apparent through the following description and the accompanying drawings.

### Solution to Problem

A wireless communication system according to an exemplary embodiment includes: a first base station including an active antenna; and a second base station, which is an adjacent base station of the first base station. The second base station estimates, by use of an uplink reference signal from a wireless terminal, a direction of the wireless terminal with respect to the second base station, and transmits direction information, which is a result of the estimation, and location information of the second base station, to the first base station. The first base station receives the direction information and the location information of the second base station, and controls a transmission beam of the active antenna of the first base station on the basis of the direction information, the location information of the second base station, and location information of the first base station.

A base station according to an exemplary embodiment includes: an active antenna; an interface connected to a second base station which is an adjacent base station of the base station; and an active antenna system configured to control a transmission beam of the active antenna. The interface receives, from the second base station, direction information of a wireless terminal with respect to the second base station, the direction information being estimated by the second base station by use of an uplink reference signal from the wireless terminal, and location information of the second base station. The control of the transmission beam of the active antenna is performed on the basis of the direction information, the location information of the second base station, and location information of the base station itself.

A control method of a base station according to an exemplary embodiment controls a transmission beam of an active antenna included in the base station. In the control method, direction information of a wireless terminal with respect to a second base station, the direction information being estimated by the second base station by use of an uplink reference signal from the wireless terminal, and location information of the second base station are received from the second base station. In the control method, control of a transmission beam of the active antenna is performed on the basis of the direction information, the location information of the second base station, and location information of the base station itself.

A wireless communication system according to an exemplary embodiment includes: a first base station including an active antenna; a second base station, which is an adjacent base station of the first base station; and a control device connected to the first base station and the second base station. The first base station transmits location information of the first base station to the control device. The second base station estimates, by use of an uplink reference signal from a wireless terminal, a direction of the wireless terminal with respect to the second base station, and transmits direction information, which is a result of the estimation, and location information of the second base station, to the control device. The control device receives the location information of the first base station, the direction information, and the location information of the second base station, estimates location of the wireless terminal on the basis of the direction information, the location information of the second base station, and the location information of the first base station, and transmits estimated location information, which is a result of the estimation, to the first base station. The first base station controls the transmission beam of the active antenna on the basis of the estimated location information.

### Advantageous Effects of the Invention

According to the exemplary embodiments of the present invention, by using direction information of a wireless terminal estimated by an adjacent base station by use of an uplink reference signal from the terminal, a base station, which is different from the adjacent base station, controls a transmission beam of an active antenna included in the base station itself. In this way, the base station can control a transmission beam of the active antenna by use of an uplink reference signal.

### BRIEF DESCRIPTION OF DRAWINGS

FIG. 1 is a configuration diagram illustrating a wireless communication system for explaining control of a transmission beam according to an exemplary embodiment.

FIG. 2 is a block diagram illustrating a functional configuration of a base station in the wireless communication system according to the exemplary embodiment.

FIG. 3 is a schematic diagram illustrating an example of a method of measuring location of a terminal according to the exemplary embodiment.

FIG. 4 is a block diagram illustrating a functional configuration of a base station included in a wireless communication system according to another exemplary embodiment.

### DESCRIPTION OF EMBODIMENTS

Concrete exemplary embodiments are described below in detail with reference to the drawings. The same or corresponding elements are denoted by the same reference signs throughout the respective drawings, and, for clear illustration, explanation of such elements is omitted where appropriate to avoid overlap.

The multiple exemplary embodiments described below may be implemented individually or by being combined appropriately. The multiple exemplary embodiments have new features which are different from each other. Hence, the multiple exemplary embodiments contribute to achieving different aims or solving different problems, and to bringing about different effects.

According to one of the exemplary embodiments, a base station including an active antenna forms a transmission beam pattern of the active antenna by using incoming wave direction information of an uplink reference signal received by an adjacent base station from a terminal, the incoming wave direction information being shared by the base stations. This exemplary embodiment is described below in detail.

### 1. System Configuration

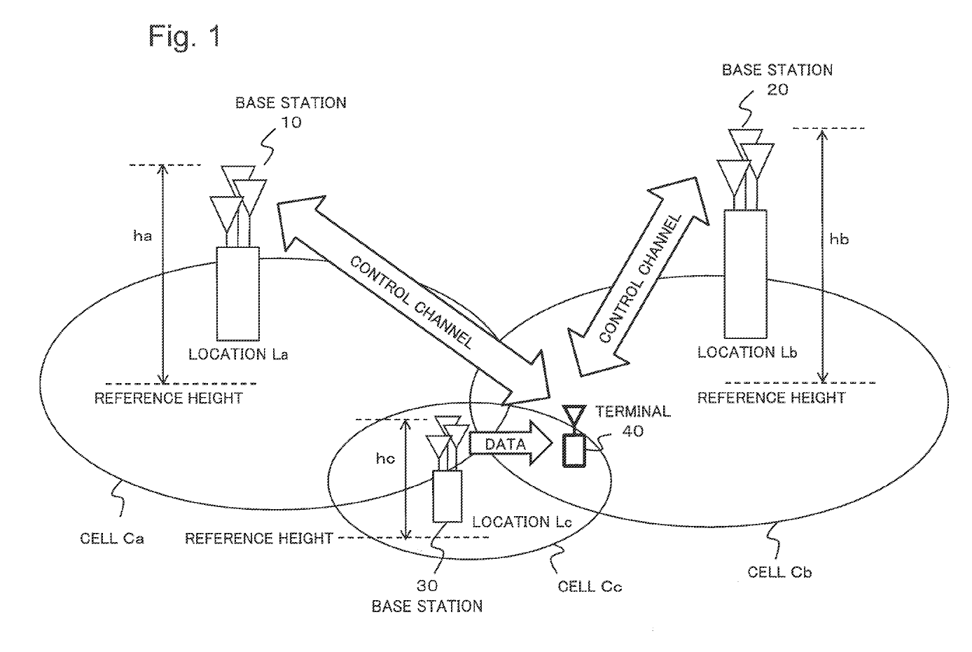

As illustrated in FIG. 1, a wireless communication system according to the exemplary embodiment includes a base station 10, a base station 20, and a base station 30. The base stations 10 and 20 are adjacent base stations that are adjacent to the base station 30. The base station 10 controls a cell Ca, and has a geographical location La (coordinates) and a height ha from a reference height (height above the sea level in this example). Similarly, the base station 20 controls a cell Cb, and has a geographical location Lb (coordinates) and a height hb from the reference height (height above the sea level in this example). The base station 30 controls a cell Cc, and has a geographical location Lc (coordinates) and a height he from a reference height (height above the sea level in this example). The base station 30 may be a base station under the control of the adjacent base station 10 or 20. The cell Cc of the base station 30 is a small cell that is smaller in size than each of the cells Ca and Cb of the base stations 10 and 20 and is also called a microcell or a picocell.

Each of the base stations 10 and 20 includes a transceiver capable of transmitting and receiving control signals and data to and from a wireless communication terminal 40 (referred to as a terminal 40 below) movable in a cell or between cells. In contrast, the base station 30 is configured to operate in a downlink transmission mode. As is described later, the base station 30 can be used exclusively for downlink data transmission to the terminal 40 via the active antenna. As is also described later, the base stations 10, 20, and 30 can communicate with each other via an exchange or a network.

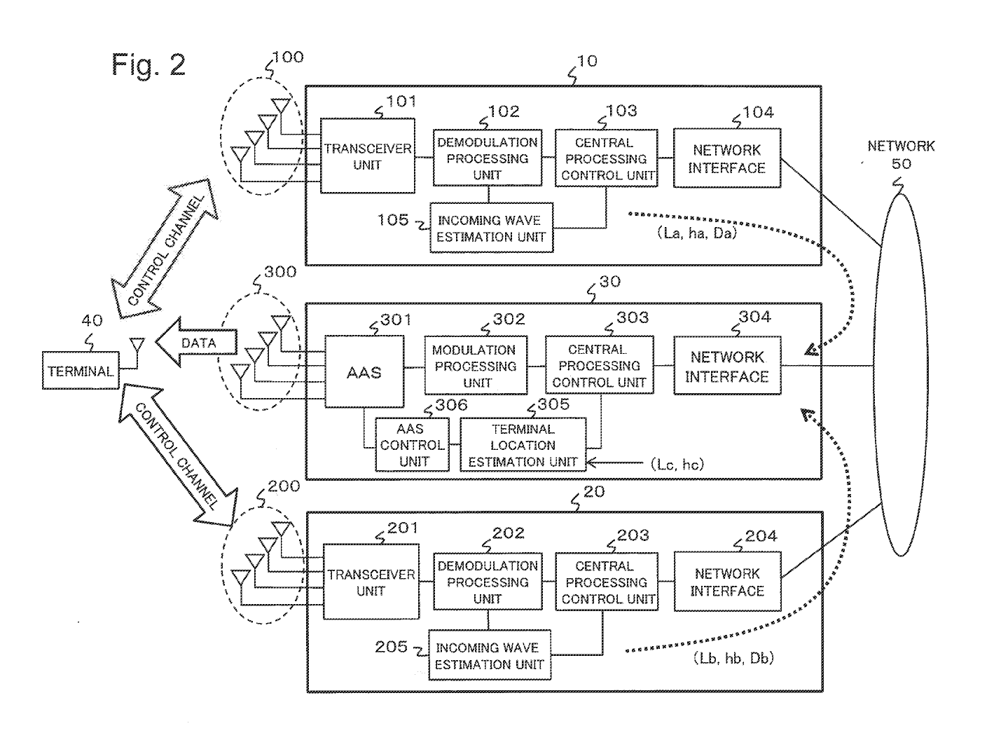

In FIG. 2, the base station 10 includes multiple antennas 100, and includes a transceiver unit 101, a demodulation processing unit 102, a central processing control unit 103, a network interface 104, and an incoming wave estimation unit 105. Note that, however, FIG. 2 only illustrates the configuration related to this exemplary embodiment, and other components, for example, a scheduler and the like, are omitted here. The base station 20 also has a similar configuration to that of the base station 10. Specifically, the base station 20 includes multiple antennas 200, and includes a transceiver unit 201, a demodulation processing unit 202, a central processing control unit 203, a network interface 204, and an incoming wave estimation unit 205. Note that, also in this case, FIG. 2 only illustrates the configuration related to this exemplary embodiment, and other components, for example, a scheduler and the like, are omitted. Equivalent functions to those of the demodulation processing unit 102, the central processing control unit 103, and the incoming wave estimation unit 105 of the base station 10 may be implementable by executing a program stored in an unillustrated memory on a computer. Similarly, equivalent functions to those of the demodulation processing unit 202, the central processing control unit 203, and the incoming wave estimation unit 205 of the base station 20 may be implementable by executing a program stored in an unillustrated memory on a computer.

The base station 30 includes an active antenna system (referred to as an AAS below) 301, which adjusts an active antenna 300, a modulation processing unit 302, a central processing control unit 303, a network interface 304, a terminal location estimation unit 305, and an AAS control unit 306.

The AAS 301 can form a beam pattern having desired directivity, by setting transmission radio frequency (RF) signals of multiple element antennas of the active antenna 300 to have certain phase differences and gain differences. Equivalent functions of the modulation processing unit 302, the central processing control unit 303, the terminal location estimation unit 305, and the AAS control unit 306 of the base station 30 can be implemented by executing a program stored in an unillustrated memory on a computer.

It is assumed that the base stations 10, 20, and 30 can communicate with each other via a network 50. Operations of the base stations 10, 20, and 30 illustrated in FIG. 2 are described below.

### 2. Operation for Controlling Transmission Beam Pattern

In FIG. 2, the base station 10 receives a control channel from the terminal 40 via the multiple antennas 100 and the transceiver unit 101. The modulation processing unit 102 extracts an uplink reference signal (or a pilot signal) from the received uplink control channel and outputs the uplink reference signal to the incoming wave estimation unit 105. The incoming wave estimation unit 105 estimates the direction from which the uplink reference signal has arrived, and outputs incoming wave direction information of the signal to the central processing control unit 103. The central processing control unit 103 transmits direction estimation information (Da, La, ha), which includes incoming wave direction information Da indicating the direction of the signal from the terminal 40, and the location information La and the height information ha of the base station 10 itself, to the base station 30 via the network interface 104 and the network 50.

The basic configuration and operation of the base station 20 are similar to those of the base station 10. The central processing control unit 203 transmits direction estimation information (Db, Lb, hb), which includes incoming wave direction information Db indicating the direction of the signal from the terminal 40, and the location information Lb and the height information hb of the base station 20 itself, to the base station 30 via the network interface 204 and the network 50.

The base station 30 receives the direction estimation information (Da, La, ha) and the direction estimation information (Db, Lb, hb) from the base stations 10 and 20 via the network interface 304 and the network 50, respectively. The central processing control unit 303 outputs the received direction estimation information (Da, La, ha) and direction estimation information (Db, Lb, hb) to the terminal location estimation unit 305.

The terminal location estimation unit 305 estimates the location and direction of the terminal 40 with respect to the base station 30 itself on the basis of the direction estimation information (Da, La, ha) from the adjacent base station 10 and the direction estimation information (Db, Lb, hb) from the adjacent base station 20 as well as the location information Lc and the height information he of the base station 30 itself, and outputs obtained estimation values to the AAS control unit 306. The AAS control unit 306 generates an AAS control signal on the basis of the direction of the terminal 40 and the distance of the terminal 40 from the base station 30 itself and outputs the AAS control signal to the AAS 301. The AAS 301 forms a directional beam pattern directed to the terminal 40 by setting transmission RF signals of the multiple element antennas of the active antenna 300 to have certain phase differences and gain differences, according to the AAS control signal.

In this way, the base station 30 can form a directional beam pattern of the active antenna 300 so that the beam pattern is directed to the terminal 40, on the basis of the geographical coordinates and heights above the sea level of the adjacent base stations 10 and 20 as well as the information on the directions of the respective adjacent base stations 10 and 20 with respect to the terminal 40. Hence, the base station 30 is capable of controlling the directivity of the active antenna 300 by way of transmission path measurement using an uplink reference signal.

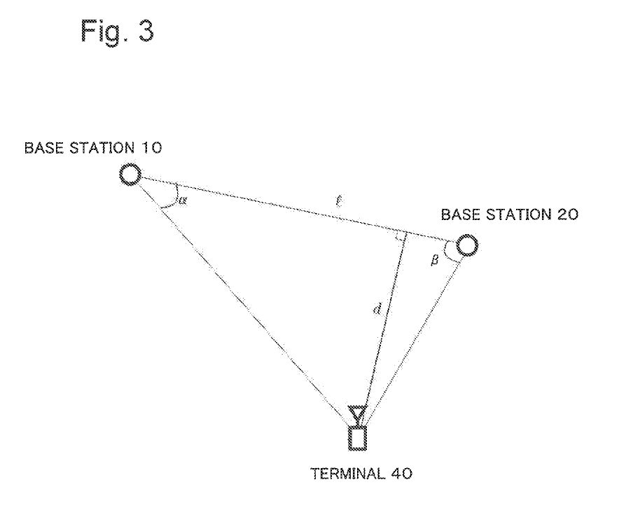

The terminal location estimation unit 305 can estimate the terminal location on the triangulation principle. For example, assume, as illustrated in FIG. 3, that the distance between the base station 10 and the base station 20 is 1, the angle of the incoming wave direction information Da of the base station 10 with respect to the direction in which the base station 20 is located is α, and the angle of the incoming wave direction information Db of the base station 20 with respect to the direction in which the base station 10 is located is β. In this case, the distance d of the terminal 40 from the straight line joining the base stations 10 and 20 is obtained according to Eq. (1) below. Eq. (1) can be turned into Eq. (3) by use of Eq. (2).

$$\begin{matrix}𝓁 = \frac{d}{tan α} + \frac{d}{tan β} \\ d + 𝓁 \text{/} ( \frac{1}{tan α} + \frac{1}{tan β} ) & ( 1 ) \\ tan α = \frac{sin α}{cos α} , sin ( α + β ) = sin α cos β + cos α sin β & ( 2 ) \\ d = \frac{𝓁 sin α sin β}{sin ( α + β )} & ( 3 )\end{matrix}$$

The distance 1 between the base station 10 and the base station 20 can be calculated using the coordinates La and Lb of the base stations 10 and 20, which are known. In other words, the location of the terminal 40 can be estimated only by detecting the directions a and 13 of the terminal 40 with respect to the respective adjacent base stations 10 and 20 on the basis of uplink reference signals.

As described above, according to this exemplary embodiment, the base station 30 operating in the downlink transmission mode can control the active antenna 300 so as to form a beam pattern directed to the terminal 40, by using the incoming wave estimation information obtained at the adjacent base stations 10 and 20, the incoming wave estimation information being shared by the base stations. In other words, the base station 30 can control a transmission beam pattern of the active antenna without performing transmission path estimation based on a reference signal of an uplink control signal. Specifically, a base station including an active antenna and operating in the downlink transmission mode forms a transmission beam pattern of the active antenna so that the beam pattern is directed to the location of a terminal estimated on the basis of incoming wave direction information of an uplink reference signal received by an adjacent base station from the terminal, on the basis of the location of the terminal. In this way, a downlink base station can control antenna's directivity by use of an uplink reference signal.

### 3. Other Embodiments

The above-described exemplary embodiment illustrates, as a general structure of base stations, the case in which the base stations 10, 20, and 30 are connected to each other via the host network 50 as illustrated in FIG. 2. Alternatively, adjacent base stations may be connected, for example, by a dedicated line. Connection by a dedicated line reduces network delay, consequently enabling to form a beam pattern in such a manner as to be excellent in following performance with respect to the movement of the terminal 40.

In FIG. 2, the base station 30 shares the incoming wave direction information from the two adjacent base stations 10 and 20. However, the present invention is not limited to this configuration.

For example, the base station 30 may control the active antenna 300 so as to form a beam pattern directed to the terminal 40, on the basis of the incoming wave estimation information obtained from at least one of the adjacent base stations 10 and 20. This configuration is described in more detail.

The base station 10 receives a control channel from the terminal 40 via the multiple antennas 100 and the transceiver unit 101. The demodulation processing unit 102 extracts an uplink reference signal (or a pilot signal) from the received uplink control channel and outputs the uplink reference signal to the incoming wave estimation unit 105. The incoming wave estimation unit 105 estimates the direction from which the uplink reference signal has arrived, and outputs the incoming wave direction information to the central processing control unit 103. The central processing control unit 103 transmits direction estimation information (Da, La, ha) including the incoming wave direction information Da indicating the direction of the signal from the terminal 40, and the location information La and the height information ha of the base station 10 itself to the base station 30 via the network interface 104 and the network 50.

The base station 30 receives the direction estimation information (Da, La, ha) from the base station 10 via the network interface 304 and the network 50. The central processing control unit 303 outputs the received direction estimation information (Da, La, ha) to the terminal location estimation unit 305. The terminal location estimation unit 305 estimates the location and direction of the terminal 40 with respect to the base station 30 itself on the basis of the direction estimation information (Da, La, ha) of the adjacent base station 10 as well as the location information Lc and height information he of the base station 30 itself, and outputs an obtained estimation value to the AAS control unit 306. The AAS control unit 306 generates an AAS control signal on the basis of the direction of the terminal 40 and the distance of the terminal 40 from the base station 30 itself and outputs the AAS control signal to the AAS 301. The AAS 301 forms a directional beam pattern directed to the terminal 40, by setting transmission RF signals of the multiple element antennas of the active antenna 300 to have certain phase differences and gain differences, according to the AAS control signal. In this way, the base station 30 can form the directional beam pattern of the active antenna 300 so that the beam pattern is directed to the terminal 40, on the basis of the geographical coordinates and the height above the sea level of the adjacent base station 10 and the information on the direction of the adjacent base station with respect to the terminal 40. In other words, the base station 30 can control the directivity of the active antenna 300 by way of transmission path measurement using an uplink reference signal.

The use of a larger number of adjacent base stations, for example, makes it possible to improve the accuracy of forming a beam directed to the terminal 40.

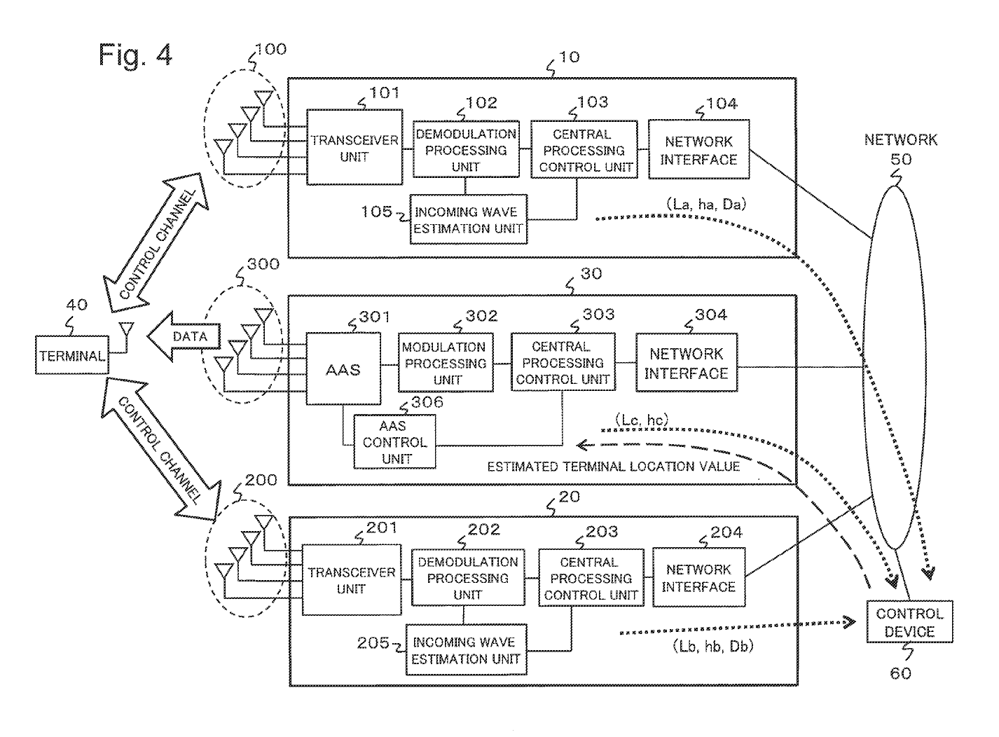

Alternatively, as illustrated in FIG. 4, a control device 60 may be connected to the network 50. The control device 60 may receive direction estimation information (Da, La, ha) of the adjacent base station 10, direction estimation information (Db, Lb, hb) of the adjacent base station 20, and location information Lc and height information he of the base station 30, estimates the location and direction of the terminal 40 with respect to the base station 30, and transmits obtained estimation values to the base station 30. In this case, the terminal location estimation unit 305 of the base station 30 is unnecessary.

The invention of the present application is described above with reference to the exemplary embodiments. However, the invention of the present application is not limited to the above-described exemplary embodiments. Various changes understandable by those skilled in the art can be made to the configuration and details of the invention of the present application within the scope of the invention of the present application.

(Supplementary Notes)

The scope of the present invention is not limited to the exemplary embodiments illustrated in the drawings and described above and includes all the exemplary embodiments possible to bring about the effects equivalent to those aimed by the present invention. In addition, the scope of the present invention may be defined by desired combinations of certain ones of all the disclosed aspects.

It is also possible to describe some of or all the above-described exemplary embodiments as in the following supplementary notes. Note, however, that each of the following supplementary notes is merely an example of the present invention, and the present invention is not limited only to the following cases.

### (Supplementary Note 1)

A wireless communication system including multiple base stations, wherein

the wireless communication system includes a base station including an active antenna and configured to operate in a downlink transmission mode, and at least two adjacent base stations connected to the base station,

each of the adjacent base stations estimates, by use of an uplink reference signal from a wireless terminal, a direction of the wireless terminal and notifies the base station of the estimated direction information of the wireless terminal together with location information of the adjacent base station, and

the base station controls a transmission beam pattern of the active antenna of the base station so that the transmission beam pattern is to be directed to the wireless terminal, on the basis of the location information of each of the adjacent base stations and the base station, and the direction information of the wireless terminal estimated by each of the adjacent base stations.

### (Supplementary Note 2)

A method of controlling a transmission beam pattern in a wireless communication system including multiple base stations, wherein the wireless communication system includes a base station including an active antenna and configured to operate in a downlink transmission mode, and at least two adjacent base stations connected to the base station,

the control method including:

each of the adjacent base stations estimating, by use of an uplink reference signal from a wireless terminal, a direction of the wireless terminal and notifying the base station of the estimated direction information of the wireless terminal, and

the base station controlling a transmission beam pattern of the active antenna of the base station so that the transmission beam pattern is to be directed to the wireless terminal, on the basis of the location information of each of the adjacent base stations and the base station, and the direction information of the wireless terminal estimated by each of the adjacent base stations.

### (Supplementary Note 3)

A base station configured to operate in a downlink transmission mode in a wireless communication system, the base station including:

an active antenna;

a communication means that receives, from each of at least two adjacent base stations, direction information of a wireless terminal estimated by each of the adjacent base stations by use of an uplink reference signal from the wireless terminal;

a terminal location estimation means that estimates location of the wireless terminal on the basis of location information of each of the adjacent base stations and the base station, and the direction information of the wireless terminal estimated by each of the adjacent base stations; and

an active antenna control means that controls a transmission beam pattern of the active antenna so that the transmission beam pattern is to be directed to the wireless terminal, on the basis of the estimated location information of the wireless terminal.

### (Supplementary Note 4)

A method of controlling a transmission beam pattern of a base station including an active antenna and configured to operate in a downlink transmission mode, the method including:

receiving, from each of at least two adjacent base stations, direction information of a wireless terminal estimated by the adjacent base station by use of an uplink reference signal from the wireless terminal;

estimating location of the wireless terminal on the basis of location information of each of the adjacent base stations and the base station, and the direction information of the wireless terminal estimated by each of the adjacent base stations; and

controlling a transmission beam pattern of the active antenna so that the transmission beam pattern is to be directed to the wireless terminal, on the basis of the estimated location information of the wireless terminal.

### (Supplementary Note 5)

A program for causing a computer to function as a base station including an active antenna and configured to operate in a downlink transmission mode, the program causing the computer to implement:

a communication function of receiving, from each of at least two adjacent base stations, direction information of a wireless terminal estimated by each of the adjacent base stations by use of an uplink reference signal from the wireless terminal;

a terminal location estimation function of estimating location of the wireless terminal on the basis of location information of each of the adjacent base stations and the base station, and the direction information of the wireless terminal estimated by each of the adjacent base stations; and

an active antenna control function of controlling a transmission beam pattern of the active antenna so that the transmission beam pattern is to be directed to the wireless terminal, on the basis of the estimated location information of the wireless terminal.

### (Supplementary Note 6)

A wireless communication system in which multiple base stations are connected to a network, the wireless communication system including:

a base station including an active antenna and configured to operate in a downlink transmission mode;

at least two adjacent base stations connected to the base station; and

a control device connected to the network, wherein

each of the adjacent base stations estimates a direction of a wireless terminal by use of an uplink reference signal from the wireless terminal and notifies the control device of the estimated direction information of the wireless terminal together with location information of the adjacent base station,

the base station notifies the control device of location information of the base station itself,

the control device estimates location of the wireless terminal on the basis of the location information of each of the adjacent base stations and the base station, and the direction information of the wireless terminal estimated by each of the adjacent base stations, and notifies the base station of the estimated location information, and

the base station controls a transmission beam pattern of the active antenna so that the transmission beam pattern is to be directed to the wireless terminal, on the basis of the estimated location information of the wireless terminal notified by the control device.

### (Supplementary Note 7)

A method of controlling a transmission beam pattern in a wireless communication system including multiple base stations, wherein the wireless communication system includes a base station including an active antenna and configured to operate in a downlink transmission mode, at least two adjacent base stations connected to the base station, and a control device connected to the network, the control method including:

each of the adjacent base stations estimating a direction of a wireless terminal by use of an uplink reference signal from the wireless terminal, and notifying the control device of the estimated direction information of the wireless terminal together with location information of the adjacent base station,

the base station notifying the control device of location information of the base station itself,

the control device estimating location of the wireless terminal on the basis of the location information of each of the adjacent base stations and the base station, and the direction information of the wireless terminal estimated by each of the adjacent base stations, and notifying the base station of the estimated location information, and

the base station controlling a transmission beam pattern of the active antenna so that the transmission beam pattern is to be directed to the wireless terminal, on the basis of the estimated location information of the wireless terminal notified by the control device.

The present application is based upon and claims the benefit of priority from Japanese Patent Application No. 2013-144536, filed on Jul. 10, 2013, the disclosure of which is incorporated herein in its entirety.

### INDUSTRIAL APPLICABILITY

The exemplary embodiments of the present invention are each applicable to a mobile communication system in which multiple base stations are located.

### REFERENCE SIGNS LIST

10, 20 base station (adjacent base station)
30 base station (base station for downlink)
40 terminal
50 network
101, 201 transceiver unit
102, 202 demodulation processing unit
103, 203 central processing control unit
104, 204 network interface
105, 205 incoming wave estimation unit
301 AAS (active antenna system)
302 modulation processing unit
303 central processing control unit
304 network interface
305 terminal location estimation unit
306 AAS control unit

1. A wireless communication system comprising:
a first base station including an active antenna; and
a second base station, which is an adjacent base station of the first base station,
wherein the second base station estimates, by use of an uplink reference signal from a wireless terminal, a direction of the wireless terminal with respect to the second base station and
wherein the second base station transmits direction information, which is a result of the estimation, and location information of the second base station to the first base station, and
wherein the first base station receives the direction information and the location information of the second base station and
wherein the first base station controls a transmission beam of the active antenna of the first base station based on the direction information, the location information of the second base station, and location information of the first base station.

2. The wireless communication system according to claim 1, further comprising a third base station, which is an adjacent base station of the first base station,
wherein the third base station estimates, by use of an uplink reference signal from the wireless terminal, a direction of the wireless terminal with respect to the third base station and
wherein the third base station transmits second direction information, which is a result of the estimation, and location information of the third base station to the first base station,
wherein the first base station receives the second direction information and the location information of the third base station, and
wherein the transmission beam is controlled based on
the location information of the first base station,
the direction information,
the location information of the second base station,
the second direction information, and
the location information of the third base station.

3. The wireless communication system according to claim 2,
wherein the third base station estimates the location and direction of the wireless terminal with respect to the first base station based on
the location information of the first base station,
the direction information,
the location information of the second base station,
the second direction information, and
the location information of the third base station, and
a result of the estimation is used for the control.

4. The wireless communication system according to claim 3,
wherein a triangulation principle is used for the estimation of the location and direction of the wireless terminal.

5. The wireless communication system according to claim 1,
wherein the first base station operates in a mode for downlink transmission to the wireless terminal.

6. A base station comprising:
an active antenna;
an interface connected to a second base station which is an adjacent base station of the base station; and
an active antenna system configured to control a transmission beam of the active antenna,
wherein the interface receives, from the second base station,
direction information of a wireless terminal with respect to the second base station, the direction information being estimated by the second base station by use of an uplink reference signal from the wireless terminal and location information of the second base station, and
wherein the transmission beam of the active antenna is controlled based on the direction information, the location information of the second base station, and location information of the base station itself.

7. The base station according to claim 6,
wherein the base station operates in a mode for downlink transmission to the wireless terminal.

8. The base station according to claim 6,
wherein the interface is connected to a third base station which is an adjacent base station of the base station, and
wherein the interface receives, from the third base station,
second direction information of the wireless terminal with respect to the third base station, the second direction information being estimated by the third base station by use of an uplink reference signal from the wireless terminal and
location information of the third base station, and
wherein the transmission beam is controlled based on:
the location information of the base station itself,
the direction information,
the location information of the second base station,
the second direction information, and
the location information of the third base station.

9. A control method of a base station for controlling a transmission beam of an active antenna included in the base station, the control method comprising:
receiving, from a second base station, direction information of a wireless terminal with respect to the second base station, the direction information being estimated by the second base station by use of an uplink reference signal from the wireless terminal and location information of the second base station; and
controlling a transmission beam of the active antenna based on the direction information, the location information of the second base station, and location information of the base station itself.

10. A wireless communication system comprising:
a first base station including an active antenna;
a second base station, which is an adjacent base station of the first base station; and
a control device connected to the first base station and the second base station,
wherein the first base station transmits location information of the first base station to the control device,
wherein the second base station estimates, by use of an uplink reference signal from a wireless terminal, a direction of the wireless terminal with respect to the second base station, and
wherein the second base station transmits direction information, which is a result of the estimation, and location information of the second base station, to the control device,
wherein the control device receives the location information of the first base station, the direction information, and the location information of the second base station,
wherein the control device estimates location of the wireless terminal based on the direction information, the location information of the second base station, and the location information of the first base station, and
wherein the control device transmits estimated location information, which is a result of the estimation, to the first base station, and
wherein the first base station controls the transmission beam of the active antenna based on the estimated location information.

11. The base station according to claim 7,
wherein the interface is connected to a third base station which is an adjacent base station of the base station, and
wherein the interface receives, from the third base station,
second direction information of the wireless terminal with respect to the third base station, the second direction information being estimated by the third base station by use of an uplink reference signal from the wireless terminal and
location information of the third base station, and
wherein the transmission beam is controlled based on:
the location information of the base station itself,
the direction information,
the location information of the second base station,
the second direction information, and
the location information of the third base station.
